(19) United States
(12) Patent Application Publication
(10) Pub. No.: US 2026/0024927 A1
(43) Pub. Date: Jan. 22, 2026

(54) TERMINAL BLOCK

(71) Applicant: Yazaki Corporation, Tokyo (JP)

(72) Inventors: Yasuhiro TANAKA, Shizuoka (JP); Yasuhiro Otsuta, Shizuoka (JP); Sota Arai, Shizuoka (JP); Masatoshi Yamada, Shizuoka (JP); Katsuya Nakano, Shizuoka (JP); Yusuke Tsutagawa, Shizuoka (JP)

(73) Assignee: Yazaki Corporation, Tokyo (JP)

(21) Appl. No.: 19/268,089

(22) Filed: Jul. 14, 2025

(30) Foreign Application Priority Data
Jul. 18, 2024 (JP) 2024-114517

(51) Int. Cl. H01R 9/22; H01R 9/24

(52) U.S. Cl. CPC H01R 9/223; H01R 9/24

(57) ABSTRACT

A terminal block includes: a housing that includes an attachment face that abuts onto an attachment target, a bus bar holder that holds a bus bar to cause the bus bar to cross the attachment face, the bus bar extending in an axial direction, and an annular recessed groove that is provided on the attachment face outside the bus bar holder around the axial direction, the annular recessed groove including a bottom face and two side walls; and a sealing member that is provided in the annular recessed groove, and has an annular shape.

### CROSS-REFERENCE TO RELATED APPLICATION(S)

The present application claims priority to and incorporates by reference the entire contents of Japanese Patent Application No. 2024-114517 filed in Japan on Jul. 18, 2024.

### BACKGROUND OF THE INVENTION

### 1. Field of the Invention

The present invention relates to a terminal block.

### 2. Description of the Related Art

As a technique relating to a conventional terminal block, for example, Japanese Patent Application Laid-open No. 2010-139017 discloses a terminal block serving as a sealing structure in which an annular dynamic seal has been attached in a circumferential groove formed on an outer circumference of a cylindrical body. In this terminal block, two protrusions that are point-asymmetrical with respect to an axis of the dynamic seal and have sizes different from each other protrude in an identical direction along the axis, and cutout portions that the respective protrusions are to be fitted into are provided in the cylindrical body to extend from the circumferential groove. This reduces a mounting error of the dynamic seal.

Meanwhile, it has been requested that such a terminal block be improved in workability by further reducing a mounting error in mounting a sealing member such as a dynamic seal for water cutoff, and the terminal block has room for further improvement.

### SUMMARY OF THE INVENTION

The present invention has been made in view of the circumstances described above, and it is an object of the present invention to provide a terminal block that can properly achieve the mounting of a sealing member.

A terminal block according to one aspect of the present invention includes a housing that includes: an attachment face that abuts onto an attachment target; a bus bar holder that holds a bus bar to cause the bus bar to cross the attachment face, the bus bar extending in an axial direction; and an annular recessed groove that is provided on the attachment face outside the bus bar holder around the axial direction, the annular recessed groove including a bottom face and two side walls that rise from the bottom face; and a sealing member that is provided in the annular recessed groove, and has an annular shape, wherein the sealing member includes a plurality of abutting portions that is provided on each of an inner side face and an outer side face in the annular shape, the plurality of abutting portions being provided in a protruding manner to abut onto each of the two side walls of the annular recessed groove, the two side walls facing the inner side face and the outer side face, and at least some abutting portions of the plurality of abutting portions come into close contact with the two side walls in a normal attachment orientation, and are exposed from the annular recessed groove in an abnormal attachment orientation, the plurality of abutting portions being located closer to the bottom face in the normal attachment orientation, and being located on an opposite side of the bottom face in the abnormal attachment orientation.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a terminal block according to an embodiment, and an attachment target;

FIG. 2 is an exploded perspective view of the terminal block according to the embodiment;

FIG. 3 is a front view of the terminal block according to the embodiment;

FIG. 4 is a partially enlarged cross-sectional view taken on section IV-IV of FIG. 3; and

FIG. 5 is a partially enlarged cross-sectional view taken on a section that corresponds to section IV-IV of FIG. 3.

### DETAILED DESCRIPTION OF THE PREFERRED EMBODIMENTS

An embodiment according to the present invention will be described below in detail with reference to the drawings. Note that this embodiment is not restrictive of this invention. Furthermore, components in the embodiment described below include components that those skilled in the art could easily replace, or substantially the same components.

### EMBODIMENT

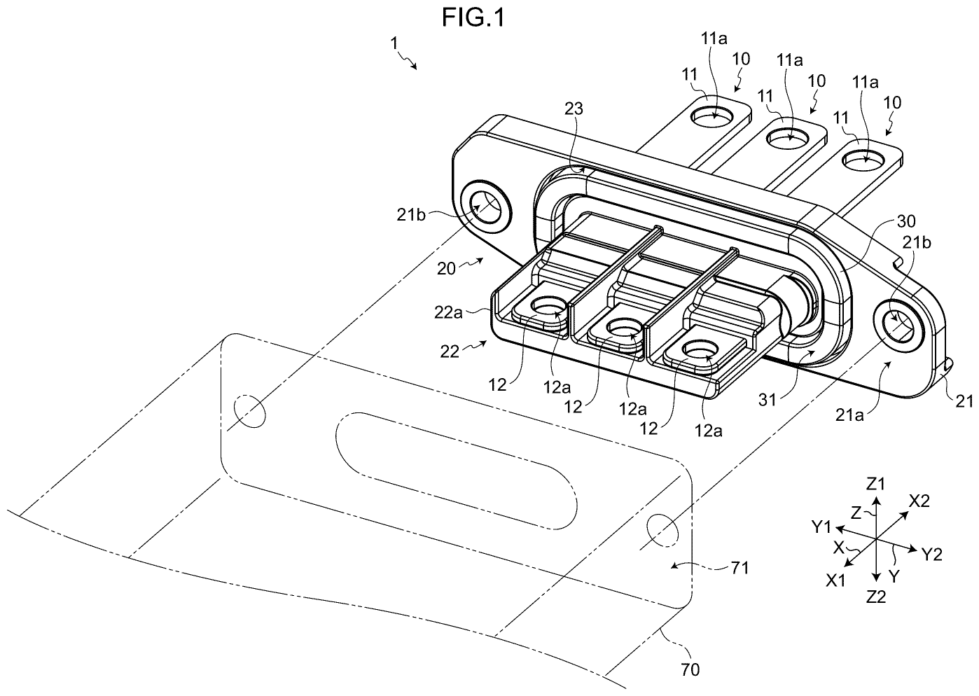

A terminal block 1 according to the present embodiment illustrated in FIG. 1 is equipped on vehicles such as electric vehicles or hybrid cars, and the terminal block 1 is attached to an attachment target 70, and relays electrical connection between a first device and a second device that are not illustrated. The terminal block 1 according to the present embodiment includes a plurality of bus bars 10, and external terminals of the first device are electrically connected to first connection portions 11 provided at one ends of the plurality of bus bars 10. Furthermore, in the terminal block 1 according to the present embodiment, external terminals of the second device are electrically connected to second connection portions 12 provided at other ends of the plurality of bus bars 10. The first device is, for example, one of a motor and an inverter, and the second device is, for example, another of the motor and the inverter. Note that the terminal block 1 is not limited to this example, and may be used, for example, for relaying between the first device or the second device and a routing material or relaying between routing materials.

In the description below, it is assumed that a direction in which the bus bars 10 extend is an axial direction X, a direction that is orthogonal to the axial direction X, and in which the plurality of bus bars 10 is arranged is a width direction Y, and a direction that is orthogonal to each of the axial direction X and the width direction Y is a height direction Z. It is also assumed that one side in the axial direction X is one side X1, and another side is another side X2. Similarly, it is assumed that one side and another side in the width direction Y are one side Y1 and another side Y2, and one side and another side in the height direction Z are one side Z1 and another side Z2.

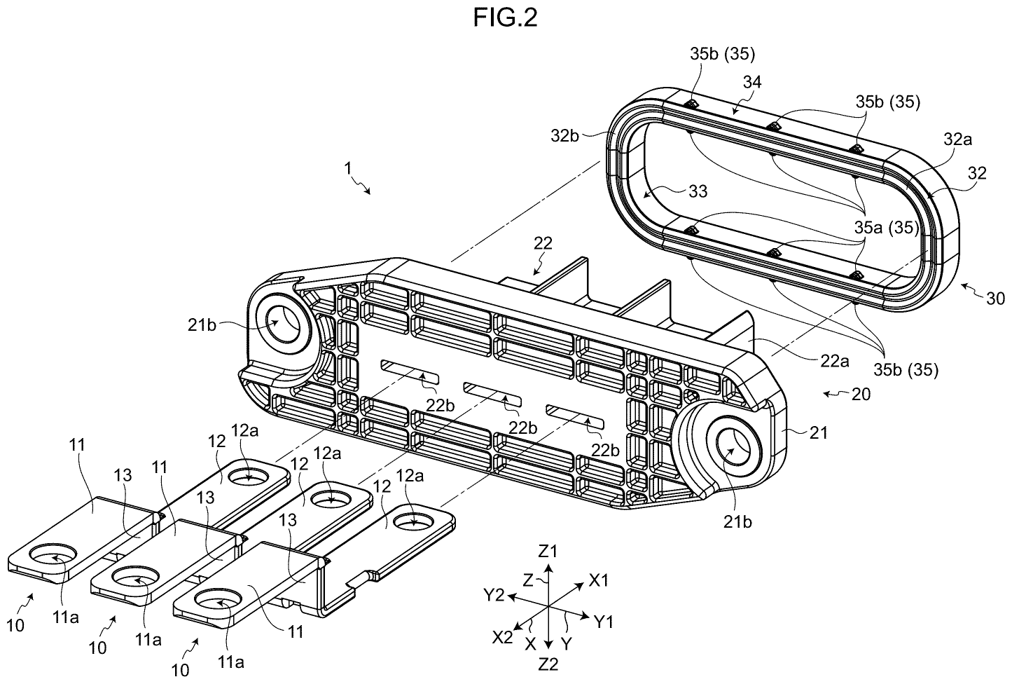

As illustrated in FIGS. 1 and 2, the terminal block 1 includes a housing 20 that is provided with the plurality of bus bars 10. The housing 20 is provided with a sealing member 30. The sealing member 30 is formed of an elastically deformable material such as rubber or resin. The bus bars 10 are terminal metal fittings that are formed of a metal material having conductivity, and are electrically and mechanically connected to the external terminals described above. In the terminal block 1, three bus bars 10 are arranged in the width direction Y.

The bus bar 10 includes the first connection portion 11, the second connection portion 12, and an intermediate portion 13 that connects the first connection portion 11 to the second connection portion 12, and various types of processing, such as bending, are performed in accordance with shapes that correspond to respective portions so that the respective portions are stereographically and integrally formed in a crank shape. Each of the first connection portion 11 and the second connection portion 12 has been formed in a plate shape that extends in the axial direction X with plate surfaces directed in the height direction Z. The intermediate portion 13 has been provided in a plate shape that roughly perpendicularly rises from an end located on the other side X2 in the axial direction X in the second connection portion 12 toward the one side Z1 in the height direction Z, is roughly perpendicularly connected to an end located on the one side X1 in the first connection portion 11, and directs plate surfaces in the axial direction X. On the other side X2 in the axial direction X in the first connection portion 11, a connection hole 11a that penetrates in the height direction Z is provided. Similarly, on the one side X1 in the axial direction X in the second connection portion 12, a connection hole 12a that penetrates in the height direction Z is provided. The connection hole 11a of the first connection portion 11 is connected to the first device described above, and the connection hole 12a of the second connection portion 12 is connected to the second device described above.

The housing 20 includes a housing body 21 that is formed of a synthetic resin material or the like having insulation, and has a roughly long rectangular plate shape in which the width direction Y is a longitudinal direction. A face located on the one side X1 in the axial direction X in the housing body 21 is an attachment face 21a that is roughly flat, and abuts onto or is close to an attachment target face 71 of the attachment target 70. An attachment hole 21b is provided near each of the ends located on the one side Y1 and the other side Y2 in the width direction Y in the housing body 21. The attachment hole 21b is a hole that penetrates in the axial direction X, a bolt (not illustrated) is inserted into the attachment hole 21b, and the terminal block 1 is fixed to the attachment target 70 via the attachment hole 21b.

In a roughly central portion in the width direction Y in the housing body 21 of the housing 20, a bus bar holder 22 is provided. The bus bar holder 22 holds the plurality of bus bars 10 that extends in the axial direction X in such a way that the plurality of bus bars 10 crosses the attachment face 21a. The bus bar holder 22 is provided with a bus bar holding protrusion 22a that protrudes toward the one side X1 in the axial direction X. The bus bar holding protrusion 22a is formed in a roughly flat plate shape in which a plate surface is directed in the height direction Z. Furthermore, the bus bar holder 22 is provided with three insertion holes 22b into which the second connection portions 12 of the bus bars 10 are to be inserted. The insertion holes 22b penetrate in the axial direction X, and correspond to a face located on the one side Z1 in the height direction Z of the bus bar holding protrusion 22a. Each of the bus bars 10 is held by the bus bar holder 22 in such a way that the second connection portions 12 are respectively inserted into the insertion holes 22b from the other side X2 in the axial direction X, and the respective second connection portions 12 are placed on the one side Z1 in the height direction Z of the bus bar holding protrusion 22a. The bus bar holding protrusion 22a is provided with a partition plate that corresponds to the three insertion holes 22b. By doing this, the bus bar holder 22 is formed to be able to hold the plurality of bus bars 10 that is arranged in the width direction Y.

Furthermore, the attachment face 21a outside the bus bar holder 22 around the axial direction X is provided with an annular recessed groove 23 in which a recessed groove has been annularly formed to surround the bus bar holder 22. The annular recessed groove 23 is formed in an oblong annular shape that is long in the width direction Y, that is, a direction in which the plurality of bus bars 10 is arranged. The sealing member 30 is fitted into the annular recessed groove 23. The sealing member 30 is formed in an oblong annular shape that is long in the direction in which the bus bars 10 are arranged.

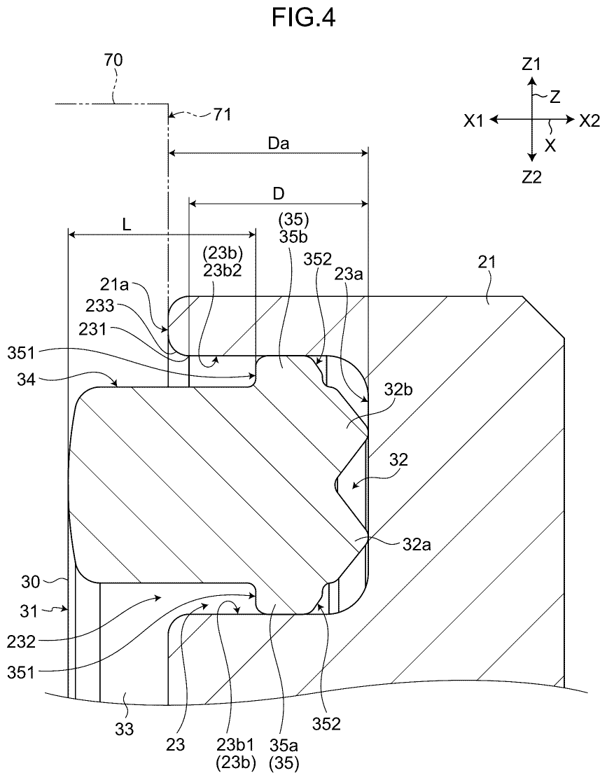

The sealing member 30 is formed to have a roughly long rectangular section (see FIG. 4). In the sealing member 30, a face located on the one side X1 in the axial direction X is a close contact face 31 that comes into close contact with the attachment target face 71 of the attachment target 70. A face located on the other side X2 in the axial direction X is provided with a groove-side close contact face 32 that is provided with two lips 32a and 32b that are formed to have a crest-shaped section. Note that the lip 32a is annularly provided on an inner side in the sealing member 30, and the lip 32b is annularly provided on an outer side in the sealing member 30.

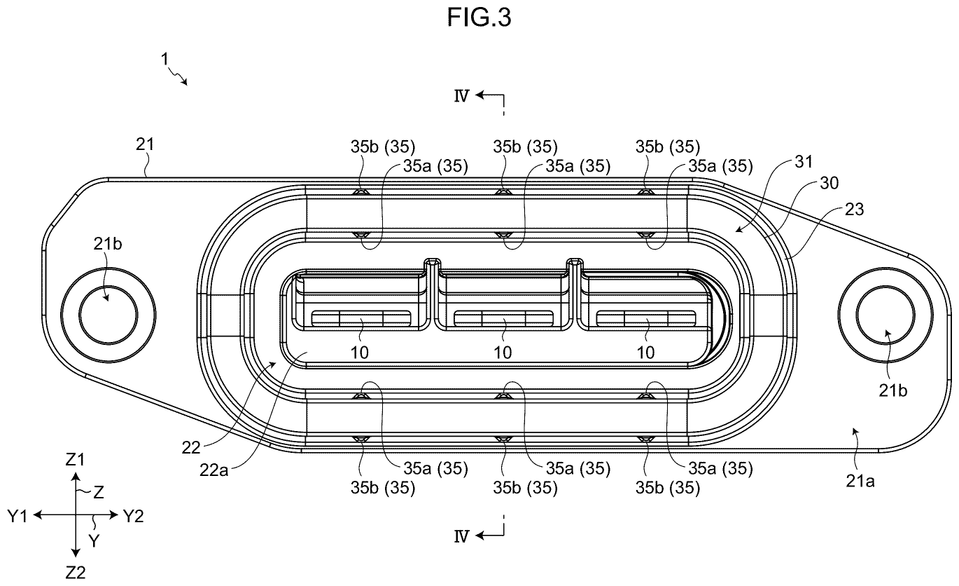

Furthermore, the sealing member 30 is provided with an inner side face 33 located on an inner side, and an outer side face 34 located on an outer side in such a way that the close contact face 31 is connected to the groove-side close contact face 32. Each of the inner side face 33 and the outer side face 34 of the sealing member 30 is provided with a plurality of abutting portions 35 that protrudes from the inner side face 33 or the outer side face 34. The plurality of abutting portions 35 includes a plurality of abutting portions 35a that is provided on the inner side face 33, and a plurality of abutting portions 35b that is provided on the outer side face 34. As illustrated in FIG. 3, the plurality of abutting portions 35 is provided on two inner side faces 33 in the width direction Y (inner side faces 33 located on the one side Z1 and the other side Z2 in the height direction Z), and two outer side faces 34 in the width direction Y (outer side faces 34 located on the one side Z1 and the other side Z2 in the height direction Z). Each of the abutting portions 35 is disposed to be spaced apart from an adjacent abutting portion 35 at a predetermined interval in the width direction Y. On the inner side face 33 and the outer side face 34 that face each other, the abutting portions 35a that are provided on the inner side face 33 and the abutting portions 35b that are provided on the outer side face 34 are disposed to face each other. By doing this, when the terminal block 1 has been attached to the attachment target 70, the sealing member 30 can be deformed in a balanced manner, and proper sealing can be achieved.

Note that no abutting portions 35 are provided on the inner side face 33 and the outer side face 34 that are located in the height direction Z, or the inner side face 33 and the outer side face 34 that are curved, and connect the inner side face 33 and the outer side face 34 that are respectively located in the width direction Y and the height direction Z. By providing the plurality of abutting portions 35 on the inner side face 33 and the outer side face 34 that are formed in a long shape in the width direction Y, the sealing member 30 can be stably held in the annular recessed groove 23.

As illustrated in FIG. 4, the annular recessed groove 23 into which the sealing member 30 has been fitted includes a bottom face 23a, and side walls 23b that rise from the bottom face 23a and include two side walls 23b1 and 23b2. The side wall 23b1 is provided on an inner side in the annular recessed groove 23, and the side wall 23b2 is provided on an outer side in the annular recessed groove 23. The abutting portions 35 are provided in a protruding manner to abut onto and come into close contact with the side walls 23b of the annular recessed groove 23 that face the inner side face 33 and the outer side face 34. Here, when the sealing member 30 has been fitted into the annular recessed groove 23, the inner side face 33 faces the side wall 23b1 located on the inner side, and the outer side face 34 faces the side wall 23b2 located on the outer side. Furthermore, the abutting portions 35 are disposed to be closer to the other side X2 in the axial direction X, that is, the groove-side close contact face 32. The close contact face 31 of the sealing member 30 slightly expands in a portion near a center between the inner side face 33 and the outer side face 34. In other words, the close contact face 31 has a gentle crest shape.

When the terminal block 1 has been attached to the attachment target 70, the attachment target face 71 of the attachment target 70 abuts onto or is close to the attachment face 21a, as illustrated with a dash-double-dotted line in FIG. 4. At this time, the sealing member 30 elastically deforms to be crushed in the axial direction X, and therefore the close contact face 31 of the sealing member 30 comes into close contact with the attachment target face 71 of the attachment target 70, and the groove-side close contact face 32 comes into close contact with the bottom face 23a of the annular recessed groove 23. Then, the sealing member 30 elastically deforms, and is almost completely housed in a space having a depth Da from the attachment face 21a to the bottom face 23a. By doing this, a gap between the close contact face 31 and the attachment target face 71 and a gap between the groove-side close contact face 32 and the bottom face 23a are sealed, and water or the like is prevented from entering the bus bar holder 22 (the bus bars 10) that is/are disposed on an inner side of the annular recessed groove 23 (the sealing member 30).

In a task of attaching the terminal block 1 to the attachment target 70, the sealing member 30 is fitted into and temporarily fastened to the annular recessed groove 23, before the terminal block 1 is attached to the attachment target 70. At this time, the plurality of abutting portions 35 abuts onto the side walls 23b, elastically deforms, and comes into close contact with the side walls 23b, and therefore the sealing member 30 is temporarily fastened to the annular recessed groove 23. Stated another way, when the sealing member 30 has been fitted into the annular recessed groove 23, the plurality of abutting portions 35 abuts onto the side walls 23b to come into pressure contact with the side walls 23b, and therefore the sealing member 30 does not easily fall off from the annular recessed groove 23. Accordingly, in attaching the terminal block 1 to the attachment target 70, the sealing member 30 can be prevented from falling off, being twisted, or being displaced.

Note that an end 352 located on the other side X2 in the axial direction X (a side of the groove-side close contact face 32) in the abutting portion 35 is formed in a tapered shape. This causes the sealing member 30 to be easily inserted into the annular recessed groove 23 in cooperation with disposition of the abutting portions 35 that are disposed to face each other, and the abutting portions 35 properly abut onto the side walls 23b, elastically deform, and come into close contact with the side walls 23b without the abutting portions 35 being twisted or unintentionally deforming.

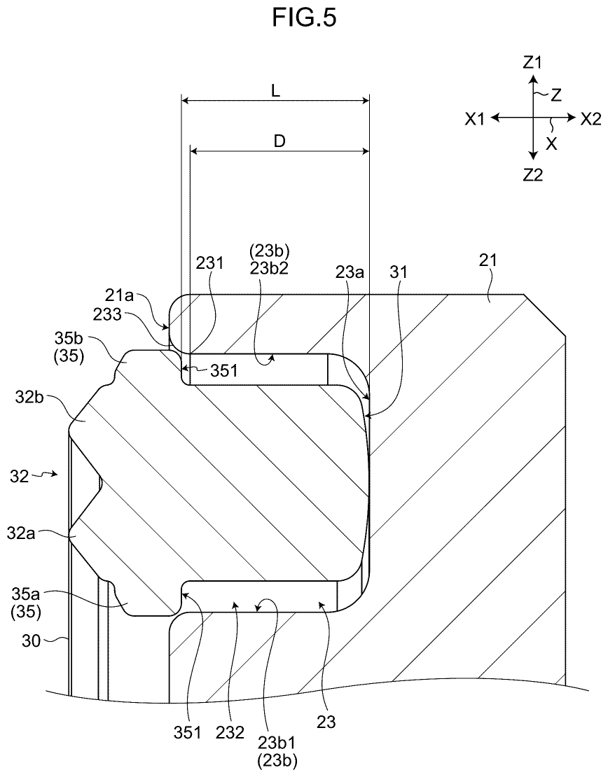

Here, it is requested that the sealing member 30 be attached to the annular recessed groove 23 in a correct orientation, that is, a normal attachment orientation, as illustrated in FIG. 4. In a case where the sealing member 30 is not attached in the normal attachment orientation, and, for example, in a case where the sealing member 30 has been attached to the annular recessed groove 23 in an abnormal attachment orientation in which the close contact face 31 is located on a side of the bottom face 23a, as illustrated in FIG. 5, there is a possibility that a gap between the attachment target face 71 and the attachment face 21a or a gap between the sealing member 30 and the bottom face 23a of the annular recessed groove 23 will not be properly sealed.

In a case where the sealing member 30 has been attached to the annular recessed groove 23 in the abnormal attachment orientation illustrated in FIG. 5, the abutting portions 35 do not abut onto or come into close contact with the side walls 23b. In the abnormal attachment orientation, the abutting portions 35 are exposed from the annular recessed groove 23. This causes the sealing member 30 to easily fall off from the annular recessed groove 23. Accordingly, even if an operator has attached the sealing member 30 to the annular recessed groove 23 in the abnormal attachment orientation, the sealing member 30 immediately falls off from the annular recessed groove 23, and therefore the operator recognizes that the sealing member 30 has been attached to the annular recessed groove 23 in the abnormal attachment orientation, before the terminal block 1 is attached to the attachment target 70.

As described above, at least some abutting portions 35 of the plurality of abutting portions 35 are disposed to be located closer to the groove-side close contact face 32 in the axial direction X, and therefore at least some abutting portions 35 come into close contact with the side walls 23b in the normal attachment orientation in which the abutting portions 35 are located on a side of the bottom face 23a, and at least some abutting portions 35 are exposed from the annular recessed groove 23 in the abnormal attachment orientation in which the abutting portions 35 are located on an opposite side of the bottom face 23a.

More specifically, as illustrated in FIGS. 4 and 5, a distance L from the close contact face 31 (far more specifically, a vertex of the close contact face 31 having a crest shape) to an end 351 located closer to the close contact face 31 in the abutting portion 35 has been set to be greater than a distance D from the bottom face 23a to an opening end position 231 of the side wall 23b where the abutting portion 35 can abut onto the side wall 23b (L>D). Here, the abutting portions 35 abut onto the side walls 23b that are formed as a flat face in the annular recessed groove 23, elastically deform, and come into close contact with the side walls 23b. However, the abutting portions 35 do not abut onto or do not come into close contact with an edge 233 that has been chamfered in an opening 232 of the annular recessed groove 23.

Accordingly, by setting the abutting portions 35 to be located closer to the opening 232 than the opening end position 231 serving as an end on a side of the opening 232 in the side wall 23b (stated another way, by setting the abutting portions 35 to be exposed from the annular recessed groove 23) in the case of the abnormal attachment orientation, the sealing member 30 fails to be temporarily fastened.

In other words, the opening end position 231 is a position of a radius curve end (an end of a curved face) located closer to the side wall 23b in an angle R at the edge 233 serving as a ridgeline that is connected to the side wall 23b and the attachment face 21a, on a side closer to the opening 232 in the annular recessed groove 23. The abutting portions 35 can come into close contact with the side walls 23b in the normal attachment orientation in which the abutting portions 35 are located closer to the bottom face 23a than this opening end position 231.

The terminal block 1 described above includes: the housing 20 that includes the attachment face 21a that abuts onto the attachment target 70, the bus bar holder 22 that holds the bus bar 10 to cause the bus bar 10 to cross the attachment face 21a, the bus bar 10 extending in the axial direction X; and the annular recessed groove 23 that is provided on the attachment face 21a outside the bus bar holder 22 around the axial direction X, the annular recessed groove 23 including the bottom face 23a and two side walls 23b (23b1 and 23b2) that rise from the bottom face 23a; and the sealing member 30 that is provided in the annular recessed groove 23, and has an annular shape, the sealing member 30 includes the plurality of abutting portions 35 that is provided on each of the inner side face 33 and the outer side face 34 in the annular shape, the plurality of abutting portions 35 being provided in a protruding manner to abut onto the side walls 23b of the annular recessed groove 23, the side walls 23b facing the inner side face 33 and the outer side face 34, and at least some abutting portions 35 of the plurality of abutting portions 35 come into close contact with the side walls 23b in a normal attachment orientation, and are exposed from the annular recessed groove 23 in an abnormal attachment orientation, the plurality of abutting portions 35 being located closer to the bottom face 23a in the normal attachment orientation, and being located on an opposite side of the bottom face 23a in the abnormal attachment orientation.

By doing this, even if the sealing member 30 has been attached in the annular recessed groove 23 of the terminal block 1, the sealing member 30 immediately falls off in the abnormal attachment orientation, and therefore the sealing member 30 is prevented from being attached to the attachment target 70 in the abnormal attachment orientation, and the sealing member 30 can be properly mounted.

More specifically, in the terminal block 1 described above, the distance L in the sealing member 30 from the close contact face 31 to the end 351 located closer to the close contact face 31 in each of the plurality of abutting portions 35 is set to be greater than the distance D from the bottom face 23a to the opening end position 231 of the side walls 23b, the opening end position 231 enabling the plurality of abutting portions 35 to abut onto the side walls 23b, the close contact face 31 coming into close contact with the attachment target 70 (L>D). By employing this configuration, the terminal block 1 can achieve a configuration in which the abutting portions 35 come into close contact with the side walls 23b in the normal attachment orientation in which the abutting portions 35 are located closer to the bottom face 23a, and the abutting portions 35 are exposed from the annular recessed groove 23 in the abnormal attachment orientation in which the abutting portions 35 are located on an opposite side of the bottom face 23a, as described above. As a result of this, the terminal block 1 can properly achieve the mounting of the sealing member 30, as described above.

Furthermore, the bus bar holder 22 is formed to be able to hold a plurality of bus bars 10 that is arranged in the width direction Y, which is a direction that is orthogonal to the axial direction X, the annular recessed groove 23 and the sealing member 30 are formed in an oblong annular shape that is long in the width direction Y, the plurality of abutting portions 35 is provided on the inner side face 33 and the outer side face 34 in the width direction Y, and abutting portions 35a that are provided on the inner side face 33 and abutting portions 35b that are provided on the outer side face 34 are disposed to face each other. This enables the sealing member 30 to be temporarily fastened to the annular recessed groove 23 in a balanced manner, and therefore the terminal block 1 can be attached to the attachment target 70 while maintaining a proper orientation of the sealing member 30, and proper sealing using the sealing member 30 can be achieved.

Note that the terminal block according to the embodiment of the present invention that has been described above is not limited to the embodiment described above, and various changes can be made without departing from the scope described in the claims.

In the description above, twelve abutting portions 35 in total have been provided on the inner side face 33 and the outer side face 34 located on the one side Z1 and the other side 22 in the height direction Z in the sealing member 30, but this is not restrictive, and an appropriate number of abutting portions 35 can be provided. Furthermore, some abutting portions of the plurality of abutting portions 35 may be exposed from the annular recessed groove 23 in the abnormal attachment orientation, and may fail to be temporarily fastened in the abnormal attachment orientation of the sealing member 30.

The terminal block according to the present embodiment may be configured by appropriately combining components in the embodiment or variations described above.

A terminal block according to the present embodiment exhibits an advantageous effect in which the mounting of a sealing member can be properly achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A terminal block comprising:
a housing that includes an attachment face that abuts onto an attachment target, a bus bar holder that holds a bus bar to cause the bus bar to cross the attachment face, the bus bar extending in an axial direction, and an annular recessed groove that is provided on the attachment face outside the bus bar holder around the axial direction, the annular recessed groove including a bottom face and two side walls that rise from the bottom face; and
a sealing member that is provided in the annular recessed groove, and has an annular shape, wherein
the sealing member includes a plurality of abutting portions that is provided on each of an inner side face and an outer side face in the annular shape, the plurality of abutting portions being provided in a protruding manner to abut onto each of the two side walls of the annular recessed groove, the two side walls facing the inner side face and the outer side face, and
at least some abutting portions of the plurality of abutting portions come into close contact with the two side walls in a normal attachment orientation, and are exposed from the annular recessed groove in an abnormal attachment orientation, the plurality of abutting portions being located closer to the bottom face in the normal attachment orientation, and being located on an opposite side of the bottom face in the abnormal attachment orientation.

2. The terminal block according to claim 1, wherein
a distance in the sealing member from a close contact face to an end located closer to the close contact face in each of the plurality of abutting portions is set to be greater than a distance from the bottom face to an opening end position of the two side walls, the opening end position enabling the plurality of abutting portions to abut onto the two side walls, the close contact face coming into close contact with the attachment target.

3. The terminal block according to claim 1, wherein
the bus bar holder is formed to be able to hold a plurality of the bus bars that is arranged in a direction that is orthogonal to the axial direction,
the annular recessed groove and the sealing member are formed in an oblong annular shape that is long in a direction in which the plurality of the bus bars is arranged, and
the plurality of abutting portions is provided on the inner side face and the outer side face in the direction in which the plurality of the bus bars is arranged, and the plurality of abutting portions that is provided on the inner side face and the plurality of abutting portions that is provided on the outer side face are disposed to face each other.

4. The terminal block according to claim 2, wherein
the bus bar holder is formed to be able to hold a plurality of the bus bars that is arranged in a direction that is orthogonal to the axial direction,
the annular recessed groove and the sealing member are formed in an oblong annular shape that is long in a direction in which the plurality of the bus bars is arranged, and
the plurality of abutting portions is provided on the inner side face and the outer side face in the direction in which the plurality of the bus bars is arranged, and the plurality of abutting portions that is provided on the inner side face and the plurality of abutting portions that is provided on the outer side face are disposed to face each other.
